(19) United States
(12) Patent Application Publication
(10) Pub. No.: US 2006/0227936 A1
(43) Pub. Date: Oct. 12, 2006

(54) STEREO X-RAY SYSTEM WITH TWO GRID-CONTROLLED X-RAY TUBES

(76) Inventors: Zegang Dong, Arlington, VA (US); Robert Ledley, Laurel, MD (US)

Correspondence Address: Zegang Dong, 122 N Wayne St, Apt 4, Arlington, VA, 22201, US

(21) Appl. No.: 11/306,948

(22) Filed: Jan. 17, 2006

Related U.S. Application Data
(60) Provisional application No. 60/593,478, filed on Jan. 18, 2005.

(51) Int. Cl. H01J 35/00

(52) U.S. Cl. 378/121

(57) ABSTRACT

A stereo x-ray system includes two grid-controlled x-ray tubes, a high voltage generator, a grid controller and an x-ray detector. The two grid-controlled x-ray tubes are aligned side by side and their anodes are apart from each other for a short distance. The x-ray output ports of the two x-ray tubes aim at the direction perpendicular to the x-ray detector. The two grid-controlled x-ray tubes are switched on/off in turn and irradiate the subject with alternating x-ray fields; thus, the left and right view x-ray images are alternately formed on the same x-ray detector. The left and right view x-ray images are independently transmitted to the image processing system. After necessary image processing, the stereo image pair is used for stereo displaying.

### CROSS-REFERENCE TO RELATED APPLICATIONS

This application is entitled to the benefit of Provisional Patent Application Ser. No. 60/593,478, filed on Jan. 18th, 2005.

### BACKGROUND

1. Field of Invention

This invention relates to an x-ray imaging system which uses two grid-controlled x-ray tubes as the radiation source to achieve stereoscopic imaging.

2. Description of Prior Art

Human beings are visual animals with 3-D perception; and stereoscopic vision can greatly increase visual acuity. However, ordinary x-ray machines can only provide two-dimensional images. The lack of depth perception sometimes hinders a radiologist's observation and judgment of the internal 3-D structures of a patient.

By using the mechanism of stereoscopic disparity, we can take a pair of x-ray images of the same subject from slightly different angles. The acquired x-ray image pair can be used for stereoscopic displaying.

Previously, various attempts were made to build stereo x-ray imaging systems; however, none of these heretofore achieved any real commercial or clinical success. There were several fundamental problems and drawbacks associated with those previous attempts.

Some used a single conventional x-ray tube as the radiation source. But in order to get the stereo x-ray image pair, the tube has to be manually or mechanically repositioned in the interval between two x-ray exposures. A typical example is the device shown in U.S. Pat. No. 6,760,469. The requirement of repositioning of the x-ray tube makes the procedure cumbersome. On the other hand, for non-flickering, real-time stereo vision, the sampling rate of the image pair should be at least 30 Hz. However, an x-ray tube cannot be mechanically repositioned that fast; therefore, such design can not achieve real-time stereoscopic imagery.

Some designs used a special stereo x-ray tube, having two anodes with their focal spots about 6 cm apart from each other. See for example: U.S. Pat. No. 4,819,255. In such designs, the image pair is acquired by alternately irradiating the subject with x-rays from the left and right anode focal spots, thus, avoiding the repositioning of the x-ray tube.

However, even with a dual-focal spot stereo x-ray tube design, the synchronization of the left and right views is still not satisfactory. Such x-ray tubes use primary switching to swap between two focal spots, i.e., the switching takes place on the primary side of the high voltage transformer. The drawback of primary switching is that, since the voltage on the secondary side of a transformer builds up relatively slowly, it is difficult to reach a switch frequency higher than 12 Hz. Therefore, the temporal discrepancy between the two views is still at the scale of 100 ms and flickers still exist for real-time stereoscopic imaging.

In addition to the problem of the synchronization of the two views, such specially-manufactured, stereo x-ray tubes are prohibitively expensive. Their complicated internal structure makes them prone to malfunctions and also difficult and expensive to repair.

### SUMMARY

In view of the disadvantages inherent in the known types of prior art, the present invention solves the aforementioned problems. Thus, it is an object of the present invention to provide non-flickering, stably working and low cost, real-time stereo x-ray imaging system.

In accordance with the present invention's object, a stereo x-ray imaging system comprises two grid-controlled x-ray tubes which can be switched on/off at a high frequency, a high-voltage generator, a grid controller and an x-ray detector.

The two grid-controlled x-ray tubes are aligned side by side. The focal spots of the two grid-controlled x-ray tubes are apart from each other for a short distance; and the output ports of the two x-ray tubes aim at the direction perpendicular to the x-ray detector. The two grid-controlled x-ray tubes are alternately switched on/off and irradiate the subject with alternating x-ray fields. By doing so, both left and right view images will be alternately formed on the same x-ray detector. The acquired left and right view x-ray images are independently transmitted to the image processing system. After necessary image processing, the image pair is used for stereoscopic displaying.

### BRIEF DESCRIPTION OF DRAWINGS

FIG. 1(a) is a schematic diagram of the x-ray source portion of this invention (x-ray detector not included).

FIG. 1(b) is a side-view, schematic diagram of a grid-controlled x-ray tubes.

FIG. 2 is a block diagram of an exemplary embodiment of this stereo x-ray system.

FIG. 3 is a diagram which shows the synchronization between the alternating x-ray fields and the image acquisitions for both views (the switching frequency is adjustable within certain range; this example is shown with a frequency of 30 Hz).

### DETAILED DESCRIPTION

A stereo x-ray system according to one exemplary embodiment of this invention will be explained below with reference to the accompanying drawings.

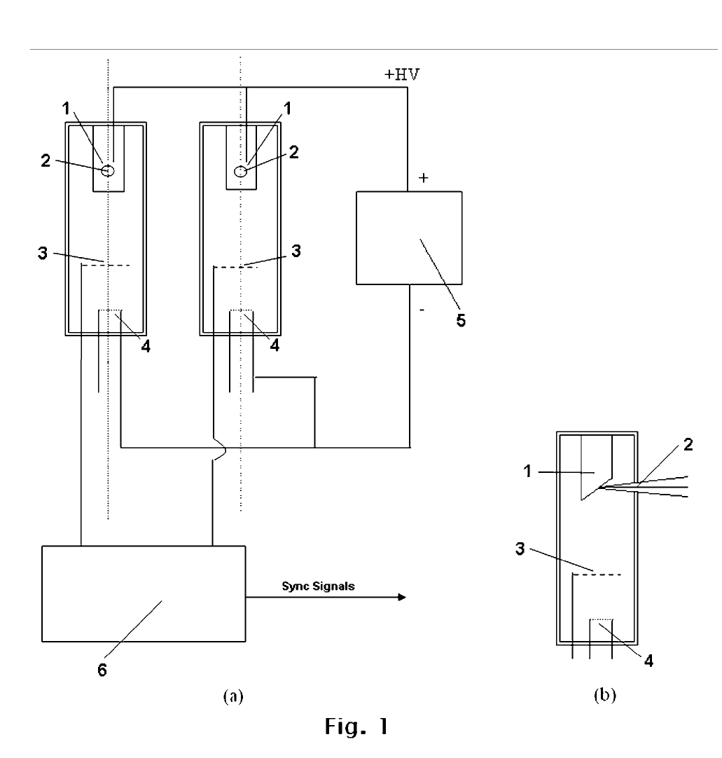

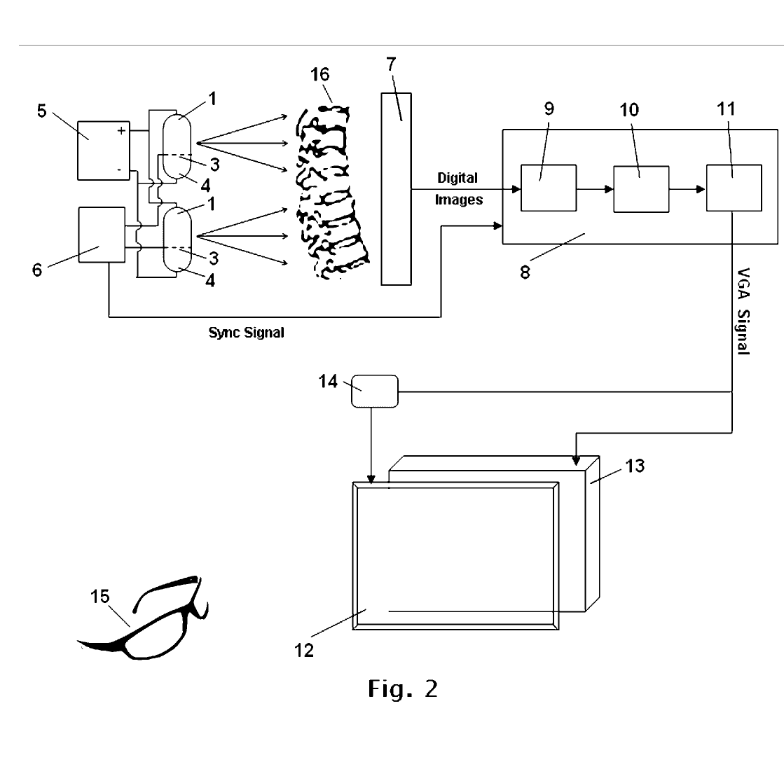

FIG. 1(a) shows the major components of the x-ray source portion of this invention (x-ray detector not included). Two grid-controlled x-ray tubes are aligned side by side and their anodes 1 are apart from each other for a short distance. The x-ray output ports 2 of the two x-ray tubes aim at the direction perpendicular to the x-ray detector 7 (not shown in FIG. 1, see FIG. 2). The high voltage generator 5 supplies electrical current at high voltages to x-ray tubes. The grid-controller 6 provides a negative voltage at the scale of several KV (relative to the cathode potential). This negative voltage is called the grid-controlled voltage, which swaps between the two grids 3 of two x-ray tubes. When the grid-control voltage is applied to the left x-ray tube's grid, the generated negative electrical field totally blocks the electron flow between the cathode 4 and the anode 1. The blockage of the tube current completely stops the generation of x-rays from the left tube. At the same time, the tube current of the right x-ray tube is not blocked; and the right x-ray tube continues radiating x-rays form its output port 2. After a predetermined short period, the grid-control voltage is switched to the right tube's grid 3 and blocks the tube current of the right tube and thus, its x-ray production. Meanwhile, the left grid-controlled x-ray resumes its tube current and radiates x-rays from its output port 2. In concert with the back and forth switching of the grid-control voltage, sync signals are generated by the grid-controller 6 to coordinate the image acquisition. The grid-controller 6 is programmable for any switching frequency in a reasonable range. To better illustrate the internal structure of a grid-controlled x-ray tube, FIG. 1(b) is a side-view, schematic diagram of a grid-controlled x-ray tube.

FIG. 2 is a block diagram of an exemplary embodiment of this stereo x-ray system. As mentioned in the description of FIG. 1(a), the two grid-controlled x-ray tubes are alternately switched on/off and irradiate the subject 16 in turn. This leads to the alternate formations of the left and right view x-ray images on the x-ray detector 7. Triggered by sync signals from the grid-controller 6, the image acquisition system grabs the left and right view images from the x-ray detector 7 in sequence. The acquired digital image data is transmitted to the workstation 8 through a PCI acquisition board 9. The stereo image processing software 10 removes the noise from the acquired image pair and applies other necessary image processing algorithms. The processed image pair is then sent to stereo-ready graphics card 11 for stereoscopic displaying. A stereoscopic viewing panel 12 is attached to a stereo-ready monitor 13. The stereo-ready graphics card 11 swaps the left and right view images alternately on the stereo-ready monitor 13 at a predetermined rate. At the same time, the stereo-ready graphics card 11 sends VGA sync signals to the synchronization controller 14 of the stereoscopic viewing panel 12. Accordingly, the viewing panel circularly polarizes the left and right view images on the stereo-ready monitor 13 alternately in opposing directions. When corresponding passively polarized eyewear 15 are worn, the viewer sees real-time, non-flickering stereoscopic imagery.

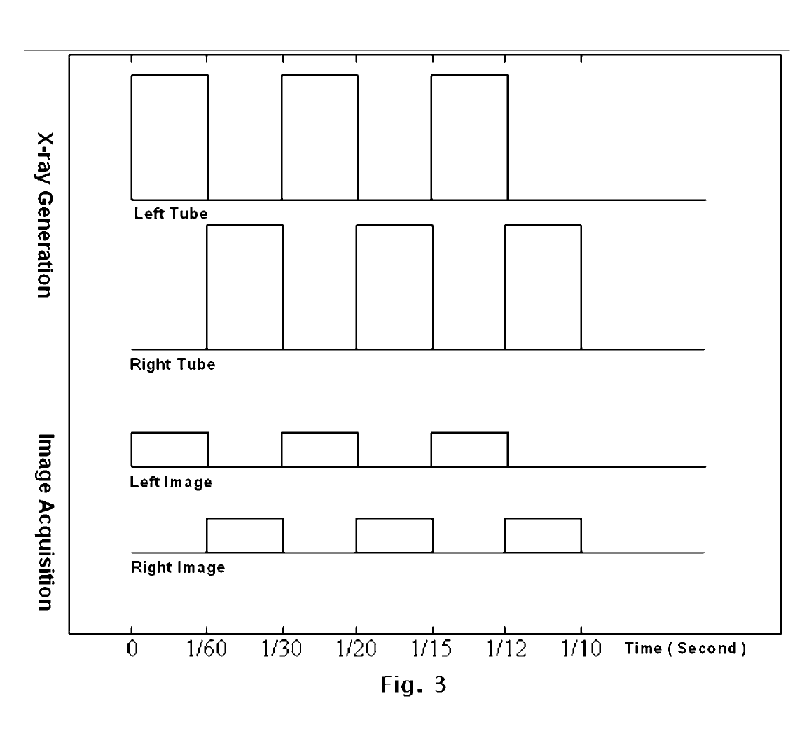

In FIG. 3, we use a switching frequency of 30 Hz as an example to show the synchronization between x-ray fields generated by the two grid-controlled x-ray tubes and the image acquisitions for the two views. When the left grid-controlled x-ray tube generates x-rays (the rectangles in this diagram only represent the on/off of the x-ray tubes, not the real waveform of x-rays), a left view x-ray image is formed on the x-ray detector. Triggered by the sync signal, the image acquisition system grabs one frame of the left view images. After a short period (in this example, 1/60 second), the left x-ray tube stops x-ray production. Meanwhile, the right x-ray tube begins to generate x-rays; and a right view x-ray image is formed on the x-ray detector. At the same time, a sync signal triggers the acquisition of the right view image. After that, the system enters a new cycle and repeats the same steps.

What is claimed is:

1. A stereo x-ray system comprising: two grid-controlled x-ray tubes; a high voltage generator; a grid controller; an x-ray detector.

2. A stereo x-ray system as claimed in claim 1, wherein said two grid-controlled x-ray tubes are aligned side by side and their anodes are apart from each other for a short distance; said x-ray output ports of said two x-ray tubes aim at the direction perpendicular to said x-ray detector.

3. A stereo x-ray system as claimed in claim 1, wherein said two grid-controlled x-ray tubes are switched on/off in turn and irradiate the subject with alternating x-ray fields; thus, the left and right view x-ray images are alternately formed on said x-ray detector.

4. A stereo x-ray system as claimed in claim 1, wherein said left and right view x-ray images, which are alternately formed on said x-ray detector, are transmitted independently to said image processing system. After necessary image processing, said stereo image pair is used for stereo displaying.

5. A stereo x-ray system as claimed in claim 1, wherein said grid controller swaps the grid-control voltage between said left and right grids of said two x-ray tubes; thus, said left and right grid-controlled x-ray tubes are switched on/off alternately.

6. A stereo x-ray system as claimed in claim 1, wherein said grid controller generates sync signals to coordinate said image acquisition of said left and right view x-ray images.
